(19) United States
(12) Patent Application Publication
(10) Pub. No.: US 2010/0302682 A1
(43) Pub. Date: Dec. 2, 2010

(54) Magnetic Recording Media Having Recording Regions and Separation Regions That Have Different Lattice Constants and Manufacturing Methods Thereof

(76) Inventors: Tatsuya Hinoue, Odawara-shi (JP); Hiroshi Yakushiji, Odawara-shi (JP); Toshinori Ono, Tama-shi (JP); Hiroyuki Suzuki, Fujisawa-shi (JP); Hiroshi Inaba, Yokohama-shi (JP); Masae Suzuki, Fujisawa-shi (JP)

Correspondence Address: ZILKA-KOTAB, PC- HIT, P.O. BOX 721120, SAN JOSE, CA, 95172-1120, US

(21) Appl. No.: 12/777,982

(22) Filed: May 11, 2010

(30) Foreign Application Priority Data
May 26, 2009 (JP) 2009-126258

(51) Int. Cl. G11B 5/82

(52) U.S. Cl. 360/135; G9B/5.293

(57) ABSTRACT

According to one embodiment, a magnetic recording medium includes a magnetic recording layer formed above a substrate, the magnetic recording layer being comprised of an alloy having a crystal structure, recording tracks formed on the magnetic recording layer in nearly concentric circular shapes, wherein the recording tracks are comprised of a first alloy composition having a crystal structure, and track separation regions formed between the recording tracks on the magnetic recording layer, wherein the track separation regions are comprised of a second alloy composition having a crystal structure, the second alloy composition comprising the first alloy composition and a non-magnetic element, wherein a lattice constant of the second alloy composition is greater than a lattice constant of the first alloy composition. In other embodiments, methods of manufacturing magnetic recording media and systems using magnetic recording media are described.

### RELATED APPLICATIONS

The present application claims priority to a Japanese Patent Application filed May 26, 2009, under Appl. No. 2009-126258, which is incorporated herein by reference.

### FIELD OF THE INVENTION

The present invention relates to magnetic recording media, and specifically to a magnetic recording media having separation regions between track regions.

### BACKGROUND OF THE INVENTION

Over the past few years, demand has heightened for larger capacity and higher performing magnetic recording and playback devices because of the increase in the amount of information used in personal computers and the like and the spread of applications to, for example, video recording devices, mobile telephones, car navigation systems, etc.

To achieve higher recording density, different methods may be pursued. In one method, the magnetization reversal unit of the magnetic recording media may be decreased and the medium noise reduced. A method used with conventional magnetic recording media is to adopt a structure in which the ferromagnetic crystalline powder forming a magnetic recording layer is separated by a non-magnetic material included beforehand in the magnetic recording layer.

Currently, several proposals for controlling the separation regions to improve the magnetic recording density have been presented, in the cases of discrete track media (an example of which is shown in FIG. 1) which had a separation process applied between the recording tracks, and bit patterned media (an example of which is shown in FIG. 2) which had a separation process applied between recording bits. These methods have been researched and developed. In both cases, the processing technique for forming the separation regions becomes an important element in increasing the recording density, and a problematic area of manufacturing these recording medium.

For example, for discrete track media, one proposed processing technique for forming the separation regions is a substrate process which fabricates depressed and projected shapes in concentric circular shapes in advance on or above a substrate and forms a magnetic film thereon to produce depressed and projected shapes in the magnetic film. In this approach, a magnetic film process may form a mask on a magnetic film, and depressed and projected shapes may be fabricated from this film by etching the parts which become the depressions.

However, these techniques have a plurality of processes for filling non-magnetic material in the depressions, planarizing that surface to match the height of the magnetic film which forms the projections, and forming a protective film on the planarized surface. The problems which arise in these processes include an increase in impurities generated on the surfaces of the magnetic film and the protective film, and an increase in surface roughness. The narrowing of the gap between the magnetic head and the magnetic disk (nano-spacing), which is another feature of increasing the recording density, is also hindered due in part to the increased surface roughness.

Another method, which forms the separation regions by ion injection, has been tried to solve these problems in the current art. For example, in Japanese Unexamined Patent Application Publication No. 2007-273067, a method is disclosed which injects atoms into a portion of a Cobalt (Co)-containing magnetic film formed before the separation regions are formed, and the Co (002) or Co (110) peak intensity determined by X-ray diffraction of the magnetic film is formed to be no more than one half. A magnetic recording medium manufactured by this method has separation sections which are formed into an amorphous material, and the coercive force and the residual magnetization of the separation sections are reduced to their respective minimum. Thus, blur in writing during magnetic recording can be avoided by using this method.

However, one problem with this process is how to separate the recording tracks and the recording bits in discrete track media and bit patterned media. When the method as described above is used, the separation regions having a crystal structure are formed into an amorphous material by ion injection. Accompanying this type of major structural transformation in the separation regions, the flatness of the surface of the medium worsens, and achieving nano-spacing is difficult, e.g., the surface becomes rough. That is, stable recording and playback are no longer possible when the flying height of the magnetic head is decreased in order to increase the recording density. In other words, a problem is the inability to satisfactorily ensure the reliability of the media.

Therefore, a method of manufacturing a magnetic recording medium having larger capacity and higher performance which avoids the problems associated with conventional methods would be very beneficial. In addition, a magnetic recording medium having larger capacity and higher performance would be beneficial to applications which rely on these increased properties of magnetic recording devices.

### SUMMARY OF THE INVENTION

According to one embodiment, a magnetic recording medium includes a magnetic recording layer formed above a substrate, the magnetic recording layer being comprised of an alloy having a crystal structure, recording tracks formed on the magnetic recording layer in nearly concentric circular shapes, wherein the recording tracks are comprised of a first alloy composition having a crystal structure, and track separation regions formed between the recording tracks on the magnetic recording layer, wherein the track separation regions are comprised of a second alloy composition having a crystal structure, the second alloy composition comprising the first alloy composition and a non-magnetic element, wherein a lattice constant of the second alloy composition is greater than a lattice constant of the first alloy composition.

In another embodiment, a method for manufacturing a magnetic recording medium includes forming a magnetic recording layer above a substrate, the magnetic recording layer comprising a first alloy having a crystal structure, forming recording tracks in nearly concentric circular shapes in the magnetic recording layer, forming track separation regions between the recording tracks in the magnetic recording layer, and injecting ions of a non-magnetic element in the track separation regions of the magnetic recording layer such that a lattice constant of a second alloy crystal which comprises the track separation regions is greater than a lattice constant of the first alloy crystal.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic view of discrete track media, in accordance with one embodiment.

FIG. 2 is a schematic view of bit patterned media, in accordance with one embodiment.

FIG. 3 is a view showing a manufacturing process of a magnetic recording media according to Example 1.

FIG. 4 is a view showing a manufacturing process of a magnetic recording media according to Example 1.

FIG. 5 is a view showing a manufacturing process of a magnetic recording media according to Example 1.

FIG. 6 is a view showing a manufacturing process of a magnetic recording media according to Example 1.

FIG. 7 is a view showing a manufacturing process of a magnetic recording media according to Example 1.

FIG. 8 is a view showing a manufacturing process of a magnetic recording media according to Example 1.

FIG. 9 is a view showing a manufacturing process of a magnetic recording media according to Example 1.

FIG. 10 is a view showing a manufacturing process of a magnetic recording media according to Example 1.

FIG. 11 is a graph showing an X-ray diffraction spectrum according to Example 1.

FIG. 12 is a graph showing an X-ray diffraction spectrum according to Example 1.

FIG. 13 is a graph showing an X-ray diffraction spectrum according to Comparative Example 1.

FIG. 14 is a graph showing evaluation results of a magnetic write width Mww according to Example 2.

FIG. 15 is a table showing evaluation results based on Mww and X-ray diffraction according to Example 2.

FIG. 16 is a view illustrating the relationship between Mww and the lattice constant ratio according to Example 2.

FIG. 17 is a table showing evaluation results of the magnetization measurements and the evaluation results of the X-ray diffraction from Test Example 1.

FIG. 18 is a graph showing the relationship between the saturated magnetization and the lattice constant ratio according to Test Example 1.

FIG. 19 is a table showing the evaluation results based on Mww and X-ray diffraction from Example 3.

FIG. 20 is a table showing the evaluation results based on Mww and X-ray diffraction according to Example 4.

FIG. 21 is a view showing the manufacturing process of the magnetic recording medium according to Test Example 2.

FIG. 22 is a view showing the manufacturing process of the magnetic recording medium according to Test Example 2.

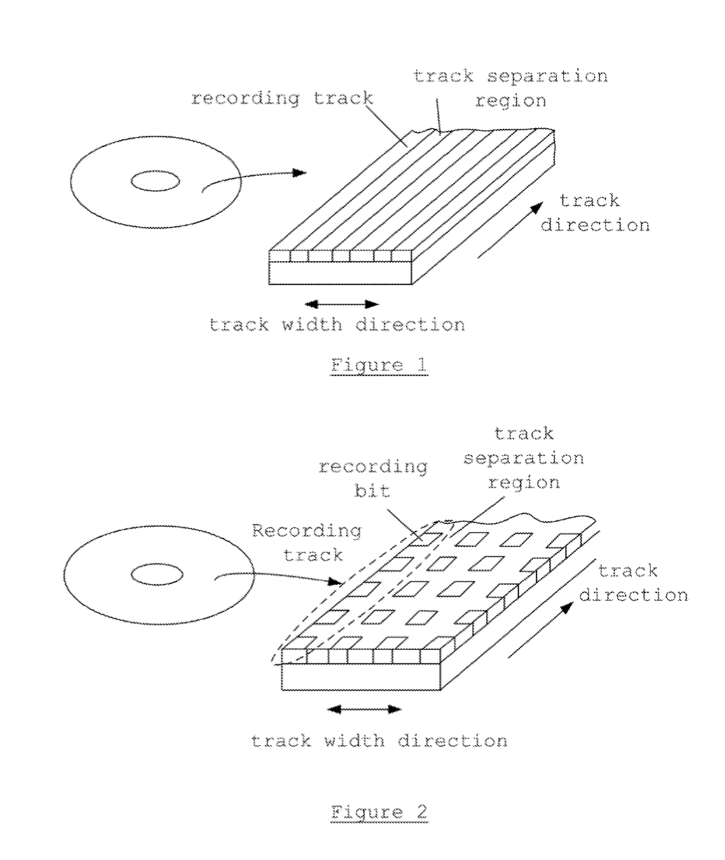

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

According to one general embodiment, a magnetic recording medium includes a magnetic recording layer formed above a substrate, the magnetic recording layer being comprised of an alloy having a crystal structure, recording tracks formed on the magnetic recording layer in nearly concentric circular shapes, wherein the recording tracks are comprised of a first alloy composition having a crystal structure, and track separation regions formed between the recording tracks on the magnetic recording layer, wherein the track separation regions are comprised of a second alloy composition having a crystal structure, the second alloy composition comprising the first alloy composition and a non-magnetic element, wherein a lattice constant of the second alloy composition is greater than a lattice constant of the first alloy composition.

In another general embodiment, a method for manufacturing a magnetic recording medium includes forming a magnetic recording layer above a substrate, the magnetic recording layer comprising a first alloy having a crystal structure, forming recording tracks in nearly concentric circular shapes in the magnetic recording layer, forming track separation regions between the recording tracks in the magnetic recording layer, and injecting ions of a non-magnetic element in the track separation regions of the magnetic recording layer such that a lattice constant of a second alloy crystal which comprises the track separation regions is greater than a lattice constant of the first alloy crystal.

One objective of the methods and devices described herein is to produce discrete track media or bit patterned media which establishes both excellent recording and playback characteristics and excellent reliability, in accordance with one embodiment. In particular, in one approach, when the separation regions are formed in discrete track media or bit patterned media by ion injection, the structure of the separation regions is appropriately controlled so that the magnetization of the separation region is sufficiently decreased while adequately ensuring the flatness of the surfaces of the media, and both a higher recording density and reliability can be established.

The magnetic recording medium, in accordance with one embodiment, has a magnetic recording layer directly or indirectly formed on a substrate. The magnetic recording layer is comprised of an alloy having a crystal structure, and has recording tracks formed into nearly concentric circular shapes and track separation regions formed between the recording tracks. The alloy composition of the track separation region has a non-magnetic element added to the alloy composition of the recording tracks, and has a structure having a larger lattice constant of the alloy crystal in the track separation regions than the lattice constant of the alloy crystal in the recording tracks, in accordance with one embodiment.

The crystal structure of the magnetic recording layer may be a hexagonal crystal or a square crystal, and the c-axis lattice constant of the alloy crystal in the track separation regions may be larger than the c-axis lattice constant of the alloy crystal in the recording tracks, in accordance with one embodiment.

The lattice constant of the alloy crystal in the track separation regions may be at least 2% greater than the lattice constant of the alloy crystal in the recording tracks, in accordance with one embodiment.

The track separation regions may comprise at least one element selected from the group composed of chromium (Cr), molybdenum (Mo), tungsten (W), and tantalum (Ta), particularly, one containing Cr is preferred, in accordance with one embodiment.

A method having a lattice constant of the alloy crystal in the track separation regions larger than the lattice constant of the alloy crystal in the recording tracks may be used for injecting ions of a non-magnetic element in the track separation regions.

At least one element selected from the group composed of Cr, Mo, W, and Ta, preferably Cr, may be used as the non-magnetic element to be ion-injected.

The injection energy during ion injection may be at least about 10 keV, in accordance with one embodiment, and between about 10 keV and about 20 keV in another embodiment.

In another embodiment, the injection dose during ion injection may be at least about 4×10¹⁶ atoms/cm², in accordance with one embodiment, and between about 4×10¹⁶ atoms/cm² and about 3×10¹⁷ atoms/cm² in another embodiment.

According to one embodiment, discrete track media and bit patterned media may be fabricated to establish both excellent recording and playback characteristics, and excellent reliability.

Working examples of embodiments of the present invention are described below with reference to the figures.

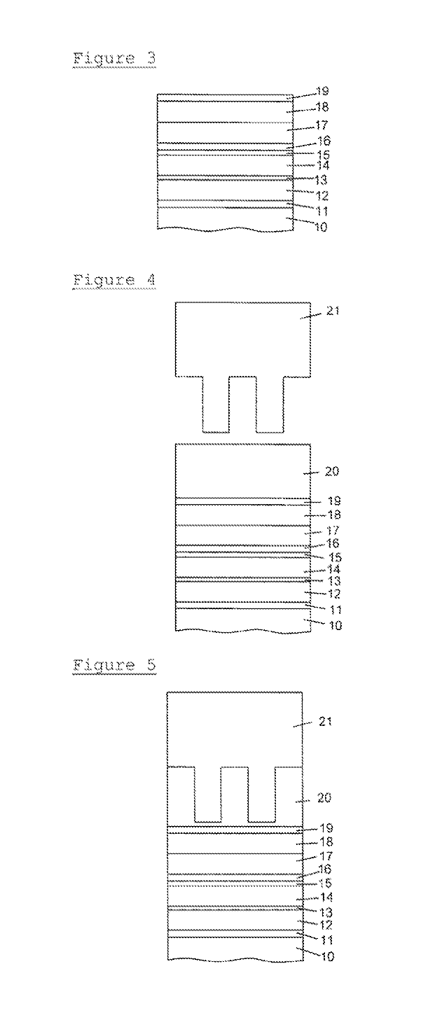

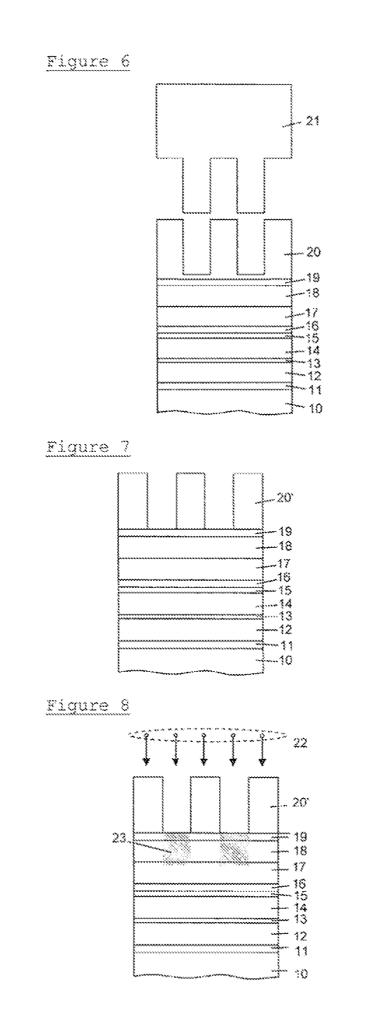

An example of magnetic recording media and the manufacturing method, in accordance with one embodiment, are described below with reference to FIGS. 3-10. In this example, a discrete track medium is fabricated, and the results of the flying tests of a magnetic head and evaluation of the recording and playback characteristics are presented, in accordance with one embodiment.

A substrate 10, which had been washed and dried, comprised borosilicate glass, aluminum silicate glass, etc., for chemically strengthening the substrate surface. Instead of the chemically strengthened glass substrate, the substrate may be an aluminum alloy substrate with Ni—P plated on the surface which is polished, a rigid substrate composed of Si, Ti, an alloy thereof, etc.

In accordance with Example 1, a 5-nm alloy layer of 50 at. % Al-50 at. % Ti was deposited as an adhesion layer 11 on the substrate processed as described above, followed by depositing a 15-nm alloy layer of 51 at. % Fe-34 at. % Co-10 at. % Ta-5 at. % Zr as a first soft magnetic layer 12, a 0.5-nm Ru layer as an anti-ferromagnetic coupling layer 13, a 15-nm alloy layer of 51 at. % Fe-34 at. % Co-10 at. % Ta-5 at. % Zr as a second soft magnetic layer 14, a 2-nm alloy layer of 50 at. % Cr-50 at. % Ti as an underlayer 15, a 7-nm alloy layer of 94 at. % Ni-6 at. % W as a first orientation control layer 16, a 17-nm Ru layer as a second orientation control layer 17, a 13-nm alloy layer of 59 mol. % Co-16 mol. % Cr-17 mol. % Pt-8 mol. % SiO₂ as a first magnetic layer 18, and a 6-nm alloy layer of 63 at. % Co-15 at. % Cr-14 at. % Pt-8 at. % B as a second magnetic layer 19 (as shown in FIG. 3). Of course, each layer may include more, less, or different materials, as would be known to one of skill in the art.

In the film deposition of each layer described above, a sheet sputtering device capable of transferring a substrate in a vacuum and successively depositing the plurality of layers as described above was used. Of course, any deposition method may be used, as would be known to one of skill in the art. Alloy targets having the same compositions as the desired film composition were prepared, and the alloy layers described above were deposited as films by sputtering the targets. The Ar gas pressure during the film deposition was 1 Pa when depositing the layers except for the second orientation control layer 17 and the first magnetic layer 18. The Ar gas pressure when depositing the second orientation control layer 17 was 1 Pa when depositing the lower 9 nm of the second magnetic control layer and 5 Pa when depositing the upper 8 nm. When depositing the first magnetic layer, oxygen was added to the Ar, and then the film was deposited. The pressure of Ar was 4 Pa, and that of oxygen was 0.2 Pa.

After a resist 20 was coated on the medium processed as described above, the pattern of the recording tracks and the servo was copied to the resist 20 by pressing a stamper 21 formed with the pattern of the recording tracks and the servo into the resist 20 (as shown in FIGS. 4-6). The residual resist film of the grooved sections of the pattern 20 was removed by reactive ion etching (RIE) using oxygen gas. The resist pattern 20′ of the servo and the recording tracks having a 100-nm track pitch, a 50-nm track width, and a 120-nm height was formed (as shown in FIG. 7).

After forming the resist pattern, Cr ions were injected as the ions 22 of the non-magnetic element into the medium, in accordance with one embodiment. Track separation regions 23 injected with Cr were formed in parts of the first magnetic layer 18 and the second magnetic layer 19 (as shown in FIG. 8). When the track separation regions 23 were formed, Cr ions were sometimes injected into parts of the second orientation control layer 17 depending on the injection energy, but there were no performance problems with the medium.

As a method for injecting ions into the medium, the method formed a plasma by an arc discharge of a cathode having the main component of the injected non-magnetic element (here, Cr), transferred the generated plasma by a curved magnetic field duct, and irradiated a plasma beam on the medium, in accordance with one embodiment. Alternately, the method for injecting the ions 22 of the non-magnetic element may use an ion beam source. Of course, any injection process may be used as would be known to one of skill in the art. The injection energy of the Cr ions was set to 20 keV, and the injection dose was set to 4×10¹⁶ atoms/cm². For comparison, samples which were not injected with ions were also fabricated. The injection energy may be changed as would be known to one of skill in the art to suit desired materials, concentrations, etc.

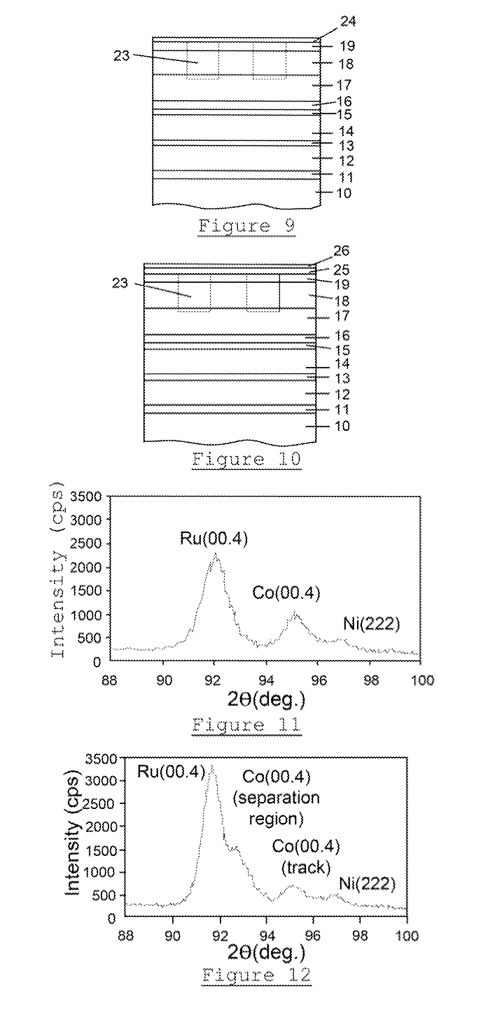

After the Cr ion injection, the resist pattern 20′ was removed by RIE using CF₄ and oxygen (as shown in FIG. 9).

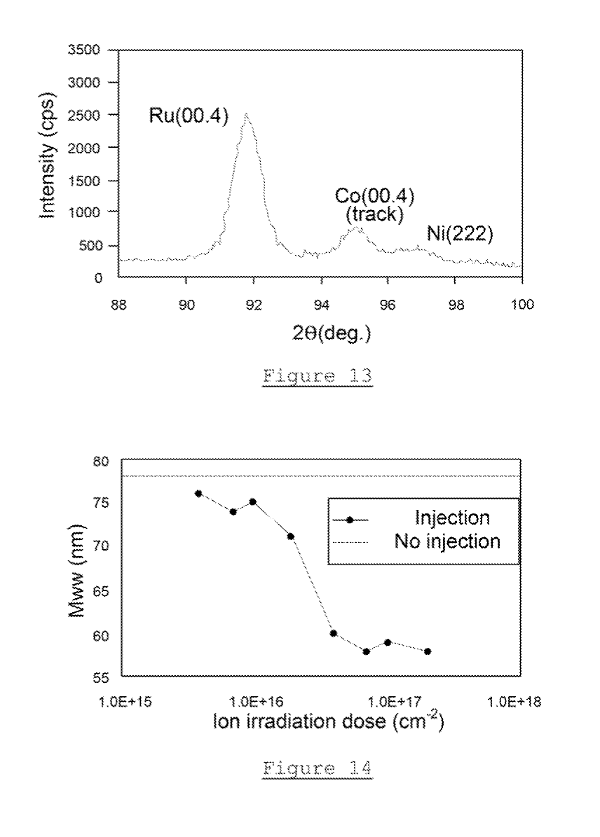

An oxide layer 24 formed on the surface of the medium by RIE was removed by sputter etching, but any method as would be known to one of skill in the art may be used. A 4-nm diamond-like carbon (DLC) protective film 25 was deposited by chemical vapor deposition (CVD), but any method as would be known to one of skill in the art may be used. A lubricant having the main component of perfluoroalkyl polyether was coated to form a 1-nm thick lubrication film 26 (as shown in FIG. 10), but any appropriate material as would be known to one of skill in the art may be used.

Instead of the DLC protective film, a carbon protective film produced by sputtering or a tetrahedral amorphous carbon (ta-C) protective film formed by using a cathodic arc method provided with an ion transport mechanism by a magnetic field filter may be used, in some embodiments.

The magnetic write width (Mww) of the fabricated medium was evaluated by using a spin stand. The magnetic head had a 50-nm playback track width Twr (track width of reader) and a 70-nm write width Tww (track width of writer). In discrete media, the track density may be increased because noise from the write blur region can be suppressed and the effect of a write to an adjacent track write can be reduced when the recording tracks are magnetically separated by track separation regions. Since the Mww decreases when an effective magnetic separation is produced by the track separation regions, the Mww is an index of the recording and playback characteristics.

When flying tests of the magnetic head were conducted on a medium injected with Cr ions and a medium not injected with ions, both media had good flying characteristics, and there was no difference. When the Mww was evaluated, the Mww of the medium not injected with Cr ions was 78 nm. In contrast, the Mww of the medium injected with Cr ions decreased substantially to 60 nm. In other words, by forming track separation regions 23 by Cr ion injection, the recording track width could be narrowed, and the recording and playback characteristics improved without damaging the flying characteristics of the head.

X-ray diffraction was used to evaluate the crystal structure of the fabricated medium. RINT-1400 manufactured by Rigaku was used as the X-ray device to conduct an evaluation based on the θ-2θ method. A CuKα1 beam was used as the X-ray source, the applied voltage was set to 50 kV, and the current was set to 160 mA. The optical system had a divergence slit of 1°, a scattering slit of 1°, and a light-receiving slit of 0.3 mm, and used a curved monochromator to produce a single color.

In the medium without injected Cr ions, a Ru (00.4) diffraction peak due to the second orientation control layer 17 was observed near 92.0°, a Co (00.4) diffraction peak due to the first magnetic layer 18 and the second magnetic layer 19 near 95.2°, and a Ni (222) diffraction peak due to the first orientation control layer 16 near 96.6° (as shown in FIG. 11). In contrast, in the medium injected with Cr ions, another diffraction peak was also observed near 92.7° in addition to the above described peaks (as shown in FIG. 12).

By injecting Cr ions in the track separation regions 23, the Co (00.4) diffraction peak of the track separation regions 23 appears further to the base angle side than the original Co (00.4) diffraction peak because the Co lattice in the track separation region 23 was expanded. Specifically, the peak near 95.3° is the Co (00.4) diffraction peak due to the recording tracks. The peak near 92.7° is the Co (00.4) diffraction peak due to the track separation regions 23.

By injecting an appropriate amount of Cr ions with the appropriate energy into the Co alloy, Cr atoms can be embedded in Co alloy crystals, and the lattice of the Co alloy crystal can be expanded, in accordance with one embodiment. Since the expansion of this lattice has the effect of reducing the crystal magnetic anisotropy of the Co and the exchange-coupling between Co atoms, the magnetization and coercive force of the track separation regions 23 can be markedly reduced. Thus, the tracks can be effectively separated magnetically. In particular, the crystal structure of the Co alloy is a hexagonal crystal and has large crystal magnetic anisotropy in the direction of the c axis. However, because the crystal structure has negative magnetostriction, the crystal magnetic anisotropy decreases greatly when the lattice is expanded in the direction of the c-axis. Thus, the method described above which uses the ion injection to expand the crystal lattice has a significant effect on hexagonal materials such as Co alloy.

An energy-dispersive X-ray fluorescence spectrometer (EDX) was used to analyze the concentrations of Co, Cr, and Pt in the track separation regions 23 and the recording track sections. The analysis position was set near the centers of the second magnetic layer 19 of each track separation region 23 and recording track. The concentrations of Co, Cr, and Pt in the track separation regions 23 were 59 at. %, 30 at. %, 11 at. %, respectively. In contrast, the concentrations of Co, Cr, and Pt in the recording tracks were 73 at. %, 13 at. %, and 14 at. %, respectively. The Cr concentration in the track separation regions 23 injected with Cr ions was found to be greater than the Cr concentration in recording tracks not injected with Cr ions. Specifically, by injecting Cr ions, Cr atoms were embedded in the Co alloy crystal in the track separation regions 23, and the Cr concentration in the track separation regions 23 increased. Since the Cr concentration was increased relatively in the track separation regions 23, the Co and Pt concentrations were seen to decrease relatively compared to the Co or Pt concentration in the recording tracks. However, because the concentration ratio of Pt:Co was nearly the same in the track separation regions 23 and the recording tracks, the composition of the track separation regions 23 was found to be a composition which added the injected Cr to the composition of the recording tracks. Since the B contained in the second magnetic layer could not be analyzed by this analysis, the target composition used in fabricating the medium has different concentration values.

From the above, by setting a lattice constant of the track separation regions larger than the lattice constant of the recording tracks, the gap between recording tracks can be magnetically isolated, and the recording and playback characteristics improved without harming the reliability produced by nano-spacing, in one embodiment.

In this example, it was confirmed that bit patterned media could be fabricated by forming a resist pattern 20′ of the servo and the recording tracks having a track pitch of 100 nm, a bit pitch of 100 nm, a track width of 50 nm, a bit width of 50 nm, and a height of 120 nm by forming the pattern of the recording tracks and the servo of the bit patterned media in a stamper 21, in one approach.

A medium similar to Example 1 was fabricated when the injection energy of the Cr ion injection was set to 24 keV, and the injection dose was set to 4×10¹⁶ atoms/cm². Of course, higher or lower injection doses may be used, as appropriate for desired effect and materials used.

When an evaluation of Mww as in Example 1 was attempted, the head did not stably fly, and Mww could not be properly evaluated. In addition, when an evaluation of the crystal structure by X-ray diffraction as in Example 1 was attempted, the peak of the Co (00.4) diffraction due to the track separations regions (23) did not appear (as shown in FIG. 13). When the surface of the medium in this comparative example was observed by atomic force microscopy (AFM), it was verified that a step difference of 3.2 nm was produced between a track separation region 23 and a recording track, and the surface of the track separation region 23 was lower than the surface of the recording track.

The reason for no apparent Co (00.4) diffraction peak due to the track separation regions 23 is the breakdown of the Co crystal in the track separation regions 23 and the creation of an amorphous material by ion injection. When this kind of major structural transformation occurred, the flatness of the medium surface is harmed, and problems develop in the flying characteristic of the magnetic head. In order to ensure the reliability of the medium, the crystal structure of the magnetic recording layer should be maintained, in one approach.

The surface of the medium in Example 1 was observed by AFM, but a clear step difference between the track separation regions 23 and the recording tracks could not be verified. When considered from the perspective of the AFM resolution, the step difference between the track separation regions 23 and the recording tracks for the medium in Example 1 is less than 1 nm. To ensure the flying characteristic of the magnetic head, a normal medium surface must have a surface roughness less than 1 nm when observed by AFM. Even when considered from the perspective of the size of the step difference, the medium in Example 1 can ensure satisfactory reliability for the flying characteristic of the head, and the medium in this comparative example has unsatisfactory reliability.

The media were fabricated as in Example 1 with an injection energy for Cr ion injection set to 20 keV, and the injection dose varied in the range from 4×10¹⁵ to 1×10¹⁹ atoms/cm². Of course, other injection energies and injection doses may be used to suit the materials used and desired effects, as would be known to one of skill in the art. Mww was evaluated as in Example 1. FIG. 14 shows the results.

Mww was smaller for the medium injected with ions than the medium not injected with ions. In the medium injected with ions, Mww was nearly constant at approximately 75 nm when the injection dose was no more than 1×10¹⁶ atoms/cm². Accompanying the subsequent increase in the injection dose, Mww gradually decreases and was nearly constant at approximately 60 nm in the injection dose range from 4×10¹⁶ atoms/cm² to 2×10¹⁷ atoms/cm².

Mww could not be evaluated normally for a medium injected at a rate greater than 1×10¹⁸ atoms/cm². The reasons are an extremely large injection dose of ions diffused in the recording tracks, and the magnetization of the recording tracks decreased. Therefore, an output which just enabled Mww to be normally evaluated was not obtained.

From the above, it was verified that the recording and playback characteristics could be improved by ion injection, in particular, that the Mww reduction effect was large when the ion injection dose exceeded 4×10¹⁶ atoms/cm².

The trend in the changes of Mww as described above can be explained as follows. A region having a nearly constant Mww for a low injection dose no more than 1×10¹⁶ atoms/cm² hardly decreases the magnetization of the track regions 23 and cannot adequately separate the tracks. Accompanying the increase in the injection dose, the magnetization and the coercive force of the track separation regions 23 gradually decrease; the magnetic coupling between tracks weakens; and the Mww gradually decreases. At an injection dose of at least 4×10¹⁶ atoms/cm² where Mww is nearly constant, the magnetization of the track separation regions 23 becomes nearly zero, and the tracks can be adequately separated. Although there is an improvement effect in the recording and playback characteristics if the magnetic separation between the tracks is minute, the improvement effect in the recording and playback characteristic becomes significant when the magnetization of the track separation regions becomes nearly zero, and the magnetic separation between tracks is satisfactory.

The crystal structures of the fabricated media were evaluated by using X-ray diffraction as in Example 1. FIG. 15 shows the Mww of each medium, the Co (00.4) diffraction peak position due to the recording tracks, the Co (00.4) diffraction peak position due to the track separation regions 23, the c-axis lattice constant of Co alloy calculated from these values, and the ratio of the c-axis lattice constants of Co of the recording tracks and the track separation regions 23. The Co (00.4) diffraction peak due to the track separation regions shifted to the base angle side as the injection dose of Cr ions increased, and lattice expansion was observed. In a medium for which Mww could be normally evaluated, the Co (00.4) diffraction peak due to the recording tracks does not change because Cr is not injected.

For a medium having an injection dose of at least 1×10¹⁸ atoms/cm² where Mww could not be normally evaluated, in addition to the shift of the Co (00.4) diffraction peak position due to the track separation regions 23, the Co (00.4) diffraction peak position due to the recording tracks also shifted to the base angle side. The reason is Cr ions diffuse in the recording tracks because of the extremely large dose injected and expand to the lattice constant of the recording tracks.

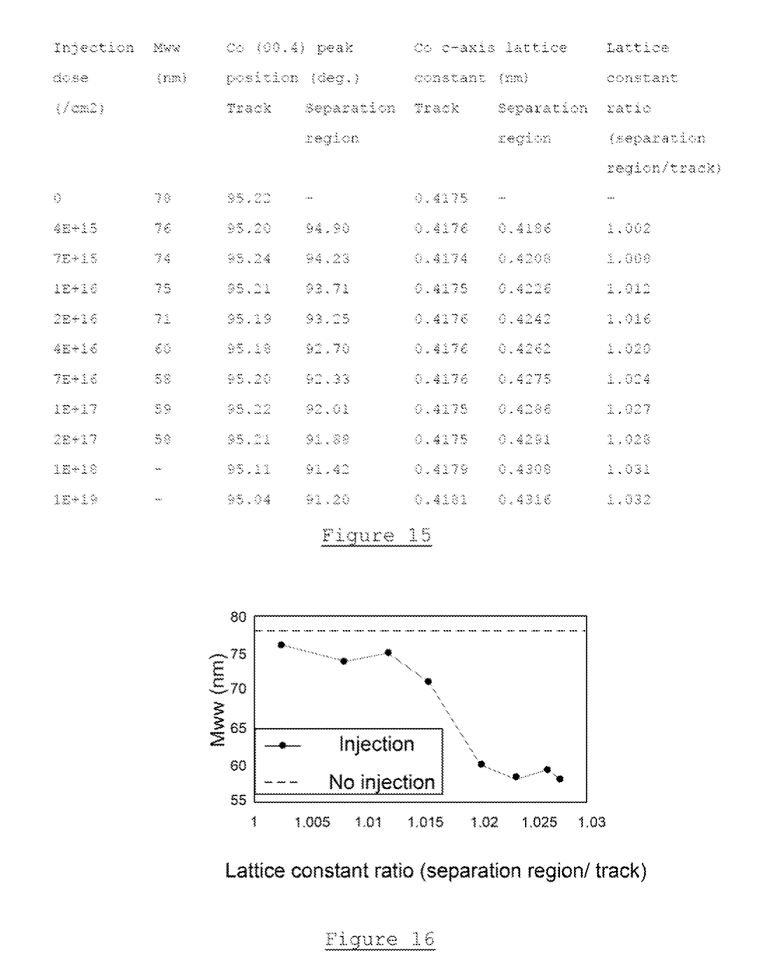

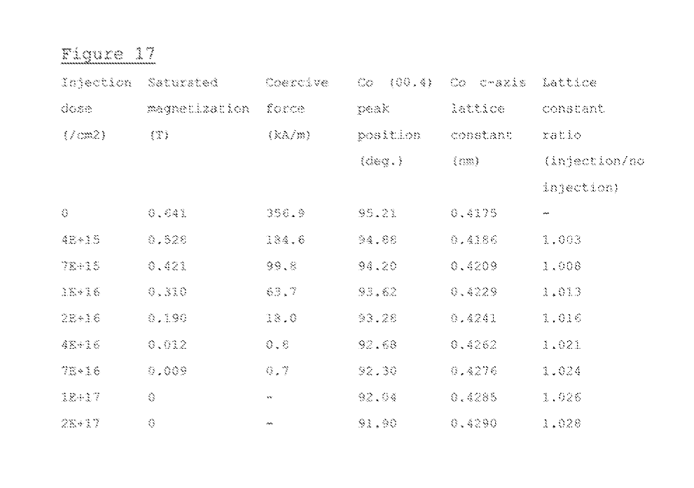

FIG. 16 is a graph showing the change in Mww with respect to the ratio of the c-axis lattice constants of Co alloy of the recording tracks and the track separation regions 23. From this graph, Mww decreases as the ratio of the lattice constants increases. When the lattice constant ratio is at least 1.02, that is, the lattice constant of the track separation regions increases by at least 2% compared to the lattice constant of the recording tracks, Mww nearly reaches a minimum value. This is a desired effect, in one approach.

For a medium having an injection dose of at least 1×10¹⁸ atoms/cm² where Mww could not be normally evaluated, the ratio of the lattice constants exceeded 1.03. From the perspective of creating amorphous track separation regions 23, there were no problems even if the ratio of the lattice constants exceeded 1.03. In practice, when a large quantity of ions is injected as the ratio of lattice constants exceeds 1.03, increasing the recording density becomes a problem because a decrease in magnetization caused by the diffusion of ions into the recording tracks develops.

From the above, the recording and playback characteristics can be improved by a lattice constant of the track separation regions being larger than the lattice constant of the recording tracks, in one embodiment. In particular, it was verified that the improvement effect in the recording and playback characteristics is large when the lattice constant of the track separation regions is at least 2% greater than the lattice constant of the recording tracks.

To confirm the effect of a change in the lattice constant of Co by ion injection reaching the magnetic characteristics, the test described below was conducted. A sample was fabricated as in Example 2 except the resist 20, the resist pattern 20′, and the lubrication film 26 were not formed. The injection energy of the Cr ions was set to 20 keV, and the injection dose varied from 4×10¹⁶ atoms/cm² to 2×10¹⁷ atoms/cm². Since the resist 20 was not coated and the resist pattern 20′ was not formed, the magnetic layer of the sample in this example is a magnetic layer similar to the track separation regions 23 in Example 1. In addition, since the recording and playback characteristics were not evaluated, the lubrication film 26 was not formed in this example.

Magnetization measurements by a vibrating sample magnetometer (VSM) and a crystal structure analysis by X-ray diffraction were conducted. FIG. 17 lists the saturated magnetization and coercive force according to the magnetization measurements of each medium, and the Co (00.4) diffraction peak position according to X-ray diffraction, the c-axis lattice constant calculated from these values, and the Co lattice constant ratio of the Co lattice constant of the medium injected with ions to the Co lattice constant of the medium not injected with ions.

It is clear that as the injection dose of the ion injections increases, the lattice constant of Co increases, the saturated magnetization and coercive force decrease, and the final saturated magnetization becomes nearly zero.

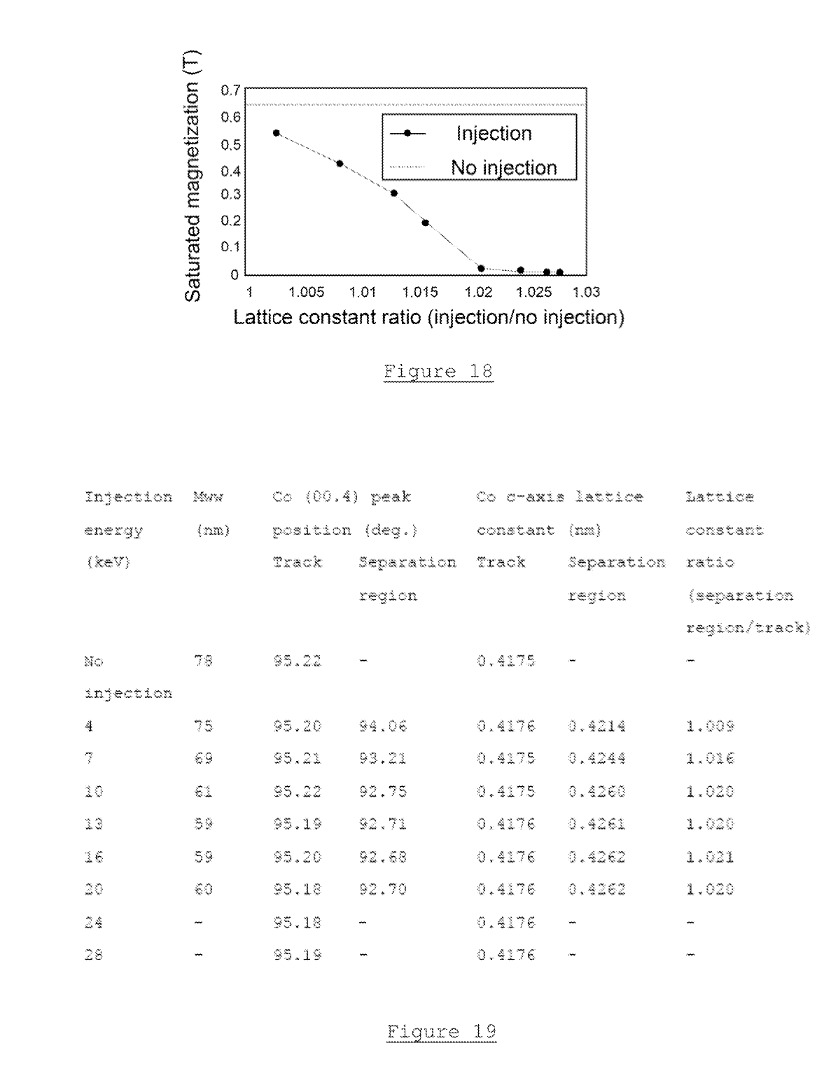

FIG. 18 is a graph showing the saturated magnetization with respect to the ratio of the Co c-axis lattice constants. From FIG. 18, it is clear that when the lattice constant ratio exceeds 102%, that is, the lattice constant of the Co alloy is 2% larger, the saturated magnetization becomes nearly zero. Mww nearly reached a minimum value in the medium in Example 2 when the lattice constant of the track separation regions 23 was at least 2% greater than the lattice constant of the tracks.

From the above, it was confirmed that the magnetization of the track separation regions 23 was reduced by ion injection, and Mww decreased depending on the final magnetization, in one approach.

Media were fabricated as in Example 1 by fixing the injection dose of Cr ion injection to 4×10¹⁶ atoms/cm², and varying the injection energy in the range from 4 to 28 keV. As in Example 1, an Mww evaluation using a spin stand and an evaluation of the crystal structure by using X-ray diffraction were conducted on the fabricated media.

FIG. 19 shows the Mww of each medium at each acceleration voltage, the Co (00.4) diffraction peak position due to the recording tracks, the Co (00.4) diffraction peak position due to the track separation regions 23, the c-axis lattice constants of the Co alloy calculated from these values, and the ratio of the c-axis lattice constants of the Co alloy of the recording tracks and the track separation regions 23. For comparison, the evaluation results of samples not injected with ions are also listed.

Mww decreased gradually as the injection energy increased above 4 keV and 7 keV, and was nearly constant when 60 nm was reached at 10 keV and higher. However, when the injection energy was 24 keV and 28 keV, the head did not fly stably, and the Mww could not be properly evaluated. In addition, the media at 24 keV and 28 keV did not exhibit the Co (00.4) diffraction peak due to the track separation regions 23 in X-ray diffraction.

When the injection energy was no more than 20 keV, it was verified that the flatness of the medium surface was maintained, and the flying characteristic of the head could be ensured because the Co crystal of the track separation regions 23 was not destroyed and the crystal structure was maintained. In addition, when the injection energy was 10 keV or higher, the recording and playback characteristics, in particular, could be improved.

The ions 22 of the non-magnetic elements to be injected were changed to Mo, W, and Ta, and media were fabricated as in Example 1. The ion injection energy was set to 20 keV, and the injection dose was set to 4×10¹⁶ atoms/cm². The Mww and the crystal structure of the media fabricated as in Example 1 were evaluated by using a spin stand and X-ray diffraction, respectively.

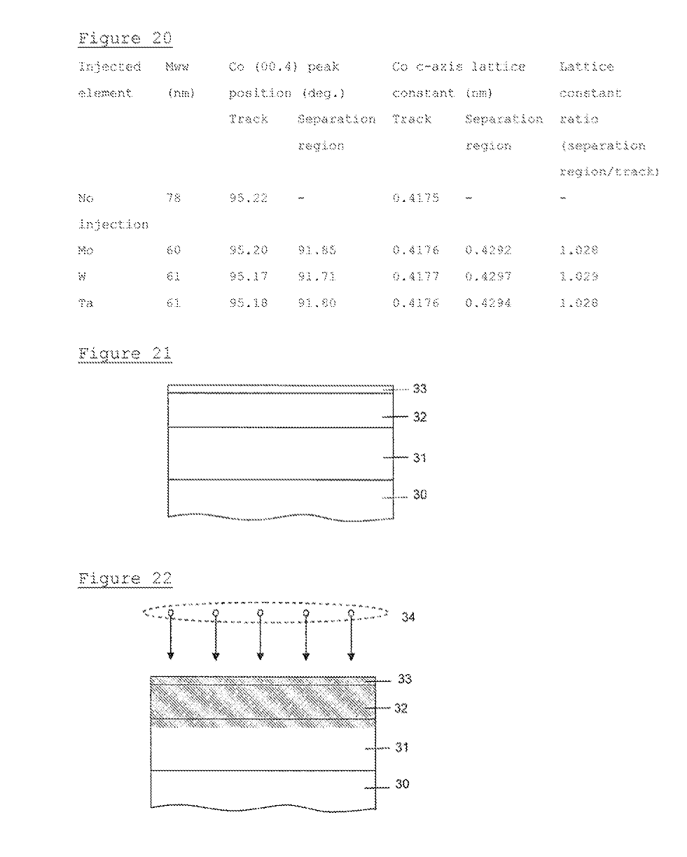

FIG. 20 shows the Mww of each medium, the Co (00.4) diffraction peak positions due to the recording tracks and the track separation regions 23 by X-ray diffraction, the c-axis lattice constants of the Co alloy calculated from these values, and the ratio of the Co c-axis lattice constants of the recording tracks and the track separation regions 23. For comparison, the evaluation results of media not injected with ions are also listed.

Ion-injected media had an Mww of approximately 60 nm, and the Mww was small compared to media which were not injected. In addition, it was confirmed that the lattice constant of the track separation regions 23 increases 2.8 to 2.9% over the lattice constant of the recording tracks for each ion injected medium.

From the above, it was confirmed that the medium of this example magnetically isolates the recording tracks by the track separation regions similar to Example 1, the track width narrowed, and the track density could be greatly increased. In other words, Mo, W, and Ta can be used as the non-magnetic elements to be injected.

However, since each element used in this example has a high melting point, electrical discharge is difficult to establish by a method which generates plasma due to an arc discharge of a cathode. Compared to the Cr used in Example 1, the cathode target must be replaced frequently. Thus, from the industrial perspective, the non-magnetic element to be injected preferably is Cr, in one approach.

The following tests were conducted to verify the effect of ion injection on magnetic recording layers other than Co alloy. FIGS. 21 and 22 illustrate the magnetic recording and playback medium and the manufacturing method of the medium according to Test Example 2, in one approach.

A monocrystal MgO substrate was used as a substrate 30, and a Pt layer was deposited as a 30-nm film as an orientation control layer 31. Of course, other materials and thicknesses may be used as would be known to one of skill in the art.

After the substrate was heated to about 600° C., a 12-nm alloy layer of 50 at. % Fe-50 at. % Pt was deposited as a magnetic layer 32, followed by the deposition of a 5-nm carbon protective film 33 (as shown in FIG. 21). Of course, other materials, temperature, and compositions may be used as would be known to one of skill in the art.

A sputtering device capable of continuously depositing films of a plurality of layers in a vacuum was used in the film deposition of each layer described above. When each layer was deposited, the Ar gas pressure was set to 1 Pa. Other pressures may also be used.

Cr ions were injected into the medium as ions 34 of a non-magnetic element by the same method as Example 1 (as shown in FIG. 22). The injection energy was set to 12 keV, and the irradiation dose was set to 3×10¹⁷ atoms/cm². As an example for comparison, a medium not injected with Cr ions was fabricated. Of course, other materials, energies, and doses may be used as would be known to one of skill in the art.

Magnetization measurements by VSM and crystal structure analysis by X-ray diffraction were conducted on the fabricated media. The saturated magnetization of the medium not injected with ions was 1.31 T. In the X-ray diffraction, the peak of an L10 structure due to FePt was observed. The FePt (004) diffraction peak position of the medium not injected with ions was 111.81°, and the calculated c-axis lattice constant was 0.3724 nm. In contrast, the saturated magnetization of the medium injected with ions was nearly zero. The FePt (004) diffraction peak position was 107.60°, and the calculated c-axis lattice constant of FePt was 0.3821 nm. The lattice constant of the medium injected with ions was approximately 2.6% greater than that of the medium not injected with ions.

From the above, similar to Example 3, it was verified that the lattice is expanded, and the magnetization becomes nearly zero by applying ion injection even in the media of this example. In particular, the FePt alloy having an L10 structure and has a large crystal magnetization anisotropy in the c-axis direction similar to a Co alloy having a hexagonal crystal. As in a hexagonal crystal, in a square crystal, the effect of ion injection becomes significant because the crystal magnetic anisotropy decreases substantially by expanding the lattice in the c-axis direction.

In another embodiment, a system includes a magnetic recording medium as described according to one of the various embodiments above, at least one magnetic head for reading from and/or writing to the magnetic recording medium, a magnetic head slider for supporting the magnetic head, and a control unit coupled to the magnetic head for controlling operation of the magnetic head.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A magnetic recording medium, comprising:
a magnetic recording layer formed above a substrate, the magnetic recording layer being comprised of an alloy having a crystal structure;
recording tracks formed on the magnetic recording layer in nearly concentric circular shapes, wherein the recording tracks are comprised of a first alloy composition having a crystal structure; and
track separation regions formed between the recording tracks on the magnetic recording layer, wherein the track separation regions are comprised of a second alloy composition having a crystal structure, the second alloy composition comprising the first alloy composition and a non-magnetic element,
wherein a lattice constant of the second alloy composition is greater than a lattice constant of the first alloy composition.

2. The magnetic recording medium as described in claim 1, wherein the crystal structure is a hexagonal crystal or a square crystal.

3. The magnetic recording medium as described in claim 1, wherein the lattice constant of the first alloy composition and the lattice constant of the second alloy composition are c-axis lattice constants.

4. The magnetic recording medium as described in claim 1, wherein the lattice constant of the second alloy composition is at least about 2% greater than the lattice constant of the first alloy composition.

5. The magnetic recording medium as described in claim 1, wherein the non-magnetic element is selected from a group consisting of chromium (Cr), molybdenum (Mo), tungsten (W), and tantalum (Ta).

6. The magnetic recording medium as described in claim 1, wherein the non-magnetic element comprises chromium (Cr).

7. A system, comprising:
a magnetic recording medium as described in claim 1;
at least one magnetic head for reading from and/or writing to the magnetic recording medium;
a magnetic head slider for supporting the magnetic head; and
a control unit coupled to the magnetic head for controlling operation of the magnetic head.

8. A method for manufacturing a magnetic recording medium, the method comprising:
forming a magnetic recording layer above a substrate, the magnetic recording layer comprising a first alloy having a crystal structure;
forming recording tracks in nearly concentric circular shapes in the magnetic recording layer;
forming track separation regions between the recording tracks in the magnetic recording layer; and
injecting ions of a non-magnetic element in the track separation regions of the magnetic recording layer such that a lattice constant of a second alloy crystal which comprises the track separation regions is greater than a lattice constant of the first alloy crystal.

9. The method as described in claim 8, wherein the first alloy crystal and the second alloy crystal are characterized in that they have a crystal structure that is a hexagonal crystal or a square crystal.

10. The method as described in claim 8, wherein the lattice constant of the second alloy crystal and the lattice constant of the first alloy crystal are c-axis lattice constants.

11. The method as described in claim 8, wherein the non-magnetic element is selected from a group consisting of chromium (Cr), molybdenum (Mo), tungsten (W), and tantalum (Ta).

12. The method as described in claim 8, wherein the non-magnetic element comprises chromium (Cr).

13. The method as described in claim 8, wherein an injection energy of injecting ions of the non-magnetic element is at least about 10 keV.

14. The method as described in claim 8, wherein an injection energy of injecting ions of the non-magnetic element is between about 10 keV and about 20 keV.

15. The method as described in claim 8, wherein an injection dose of injecting ions of the non-magnetic element is at least about 4×10¹⁶ atoms/cm².

16. The method as described in claim 8, wherein an injection dose of injecting ions of the non-magnetic element is between about 4×10¹⁶ atoms/cm² and about 3×10¹⁷ atoms/cm².
